(19) United States
(12) Patent Application Publication
(10) Pub. No.: US 2026/0026639 A1
(43) Pub. Date: Jan. 29, 2026

(54) MUSEUM SHOWCASE WITH GLASS WALLS AND SAFETY PROFILE

(71) Applicant: GOPPION S.P.A., Milano (IT)

(72) Inventor: Alessandro GOPPION, MILANO (IT)

(21) Appl. No.: 19/266,424

(22) Filed: Jul. 11, 2025

(30) Foreign Application Priority Data
Jul. 25, 2024 (IT) 102024000017332

(51) Int. Cl. A47F 3/00; E05D 5/02

(52) U.S. Cl. CPC A47F 3/005; E05D 5/0246; E05Y 2900/202

(57) ABSTRACT

The museum showcase includes a supporting frame, at least one glass wall with an inner face and an outer face, and a fixing frame glued to the inner face of the glass wall by an adhesive and mounted on the supporting frame of the showcase. The showcase also includes for each glass wall a safety profile with a fixing portion and a retaining portion. The fixing portion is fixed to the fixing frame and to the supporting frame; the fixing portion rests at least partially on the inner face of the glass wall near its lower perimeter edge. The retaining portion is hooked to the perimeter edge of the glass wall to retain the glass wall against the fixing portion of the safety profile. The weight of the glass wall is therefore also supported by the safety profile, which reduces the shear stress to which the adhesive is subjected.

### CROSS-REFERENCE TO RELATED APPLICATIONS

This patent application claims priority from Italian patent application no. 102024000017332 filed on Jul. 25, 2024, the entire disclosure of which is incorporated herein by reference.

### TECHNICAL FIELD

The present disclosure concerns a museum showcase, i.e. a showcase designed and built for the conservation and display in a protected environment of cultural assets, such as works of art, historical exhibits and the like, within the context of a display environment such as a museum, an exhibition or the like. The term showcase alone will be used below for the sake of brevity, although it still means a museum showcase.

### BACKGROUND

A protected environment is defined here and in the following as an environment in which the possibility of access to unauthorized personnel is prevented, to avoid theft or damage to the objects displayed, and in which preferably the atmosphere can be controlled, by monitoring one or more parameters between temperature, humidity, dust content, pollutant content, in order to maintain the expected storage conditions of the objects displayed.

Showcases of this type must therefore meet various requirements, in relation to the conservation and integrity of the objects displayed. Furthermore, these showcases must of course ensure the best visibility for the objects displayed.

### SUMMARY

In order to improve visibility, showcase manufacturers try as far as possible to use transparent materials—typically glass—for the walls of the showcases. In addition to ensuring the best visibility of the objects displayed, the extensive use of glass is often desired by showcase designers because the transparency of the material allows the maximum emphasis to be placed on the objects displayed, without the observer being distracted by elements other than the objects displayed in the showcase.

Traditionally, each glass wall is mechanically fixed to a supporting framing of the showcase, with the possible interposition of hinges or other opening systems if the wall is an openable wall. A widely used mechanical fixing system involves inserting the glass wall into a frame which is then fixed to the supporting frame of the showcase; another system also used involves drilling holes in the glass wall and fixing the wall to the supporting frame by means of screws or the like inserted in such holes. In both cases, however, the mechanical fixing system is clearly visible and this may be unwelcome, because it is a distracting factor for the public, whose attention should instead be focused on the objects displayed in the showcase.

For this reason, the practice of using adhesive materials for mounting glass walls has spread: a fixing frame is glued to the rear face of the glass wall with which fixing frame the glass wall is then fixed to the supporting frame of the showcase, by a mechanical fixing (with screws, bolts or other means). In this way, all the elements that contribute to the fixing of the wall are located inside the showcase and are visible on the outside only through the wall itself. To make such fixing elements even less visible, the glass wall is often provided with shielding layers (opaque films or paints) at the fixing elements, which can thus become completely invisible.

It is possible to create showcases in this way thanks to the fact that suitable adhesive materials are available, able to ensure the necessary grip on one side to the glass, on the other to the fixing frame, which is usually made of metal.

However, it was considered that the sealing of the adhesive could decrease over time, especially if the showcase has large and/or very heavy walls: in this case, in fact, the adhesive material is subjected to a very high and prolonged stress over time, which could favour its failure.

The probability that a reduction in the sealing of the adhesive occurs is very low, and even lower is the probability that there will be a total failure of the adhesive. However, the consequences of a failure of the adhesive would be very serious, both for the public and for the objects displayed. The public might be hit and injured by the fall of a wall; the objects displayed, then, could not only be hit and damaged by the fall of a wall, but they would also suddenly find themselves without the environmental protection ensured by the showcase, with potentially very serious consequences for their conservation.

Theoretically, it is possible to provide for a periodic check of the state of the adhesive material; however, such a check is burdensome and is not always possible. Therefore, faced with the risks due to a possible failure of the adhesive, especially when the showcases are large and their glass walls are very heavy, the mounting with adhesive material is often dispensed with.

The aim of the present disclosure is to allow fixing by adhesive, however, avoiding the risk that any failure of the adhesive may have dangerous consequences for the public and for the objects displayed.

This aim is solved by a museum showcase according to claim 1; preferred features are reported in the dependent claims.

More particularly, the museum showcase of the present disclosure comprises a supporting structure, at least one glass wall with an inner face and an outer face with respect to the museum showcase and with an upper perimeter edge and a lower perimeter edge, and a fixing frame glued to the inner face of the glass wall and mounted on the supporting structure of the showcase by mechanical fixing; the showcase further comprises a safety profile at the lower perimeter edge of each glass wall, comprising a fixing portion and a retaining portion, wherein the fixing portion is fixed to the fixing frame of the showcase by mechanical fixing, wherein the fixing portion at least partially rests on the inner face of the glass wall near its lower perimeter edge, and wherein the safety portion is hooked to the lower perimeter edge of the glass wall so as to support the glass wall resting against the fixing portion of the safety profile.

The weight of the glass wall is thus supported not only by the gluing of the glass wall to the fixing frame, but also by the safety profile, by means of its retaining portion. The adhesive is therefore subjected to a reduced shear stress (compared to the situation without a safety profile) and therefore maintains adhesion more easily over time. Should then a failure of the adhesive occur, with which the fixing frame is glued to the glass wall, the presence of the safety profile would prevent the sudden fall of the glass wall. In such a situation, of course, it is advisable for personnel in charge to intervene as soon as possible, because when the glass wall is supported only by the safety profile, the showcase may no longer be sealed and therefore no longer able to protect the objects displayed in it in the expected way. However, the safety profile has prevented a collapse of the glass wall on the ground and the consequent risks, both for the public who might get injured if hit by the glass wall during the fall, and for the objects displayed that—in addition to risking being hit by the glass wall—would suddenly and completely be exposed to the external environment; with the failure of the adhesive and the glass wall retained only by the safety profile, the hermetic seal of the showcase is no longer guaranteed, but the air exchange with the external environment is limited, thanks to the fact that the glass wall remains in its position, supported and retained by the safety profile.

Preferably, the retaining portion does not protrude on the outer face of the glass wall; the safety profile is thus substantially invisible from the outside and does not disturb in any way the correct view of the objects displayed in the showcase.

Preferably, the lower perimeter edge of the glass wall is inclined, so as to form an acute angle α with the inner face, and the retaining portion of the safety profile is inclined at the same acute angle α with respect to the fixing portion of the same safety profile. This configuration ensures in a simple way both the substantial invisibility of the safety profile and the efficacy of the retention action, even in the event of failure of the adhesive.

Preferably, the mechanical fixing of the fixing portion to the fixing frame provides for at least one bracket coupled to the fixing portion of the safety profile and comprising a hole (34) in which a screw (35) is inserted with which the bracket (31) is fixed to the fixing frame.

Preferably, the aforesaid screw also cooperates with the mounting of the fixing frame to the supporting structure. In this way, the safety profile is also firmly fixed to the supporting structure. Furthermore, in this way, the same screw already present for fixing the fixing frame to the supporting structure is also used to fix the safety profile.

The glass wall can be a fixed glass wall or an openable glass wall.

In the case of an openable glass wall, the supporting structure of the showcase also comprises opening members at this glass wall; the fixing frame of the openable glass wall is mounted on the opening members of the supporting structure.

In both cases, both for a fixed glass wall and for an openable glass wall, the presence of the safety profile is useful, to reduce the stress to which the adhesive is subjected and to retain the glass wall to the fixing frame even in the event of failure of the adhesive.

Preferably, the showcase comprises a further safety profile for each glass wall, at the upper perimeter edge of the glass wall. This ensures a balanced and effective retention.

### BRIEF DESCRIPTION OF THE DRAWINGS

Further characteristics and advantages of the present disclosure will be more evident from the following description of a preferred embodiment thereof, made with reference to the appended drawings.

In such drawings:

FIG. 1 is a schematic overview of a showcase according to the present disclosure;

FIG. 2 is a sectional view of an upper portion of the showcase of FIG. 1, in which an openable glass wall of the showcase and an upper ceiling of the showcase are partially visible;

FIG. 3 is a sectional view of a lower portion of the showcase of FIG. 1, in which an openable glass wall of the showcase and a lower bottom of the showcase are partially visible;

FIG. 4 is an enlarged scale view of a detail of the showcase shown in FIG. 2;

FIG. 5 is an enlarged scale view of a detail of the showcase shown in FIG. 3.

### DESCRIPTION OF EMBODIMENTS

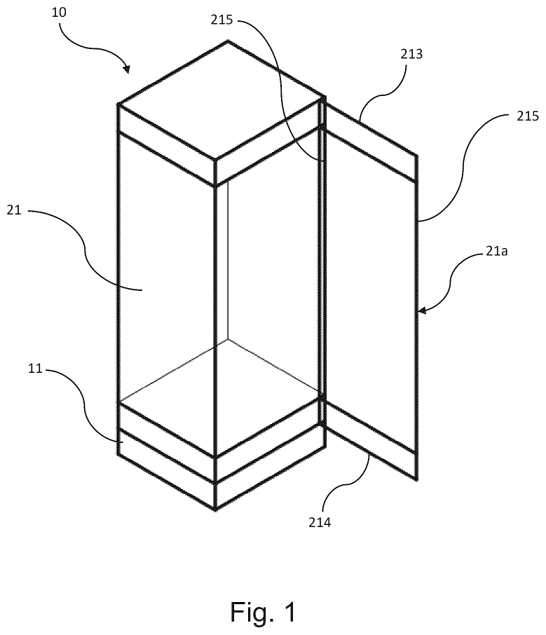

In the figures, in particular in FIG. 1, a museum showcase as a whole is indicated with 10. The showcase 10 comprises a baseplate 11, surmounted by a box formed by glass walls 21 supported by a supporting structure 12; one of the glass walls, indicated in the drawings with 21a, is openable, to allow access inside the showcase 10, while the other glass walls 21 are fixed; in the following, any reference to a glass wall 21 must be understood as also referring to the openable glass wall 21a. Constructional details of the showcase 10 unrelated to the present disclosure are not described (or highlighted in the figures).

Each glass wall 21 has an inner face 211 with respect to the showcase, an outer face 212 and four perimeter edges: an upper perimeter edge 213, a lower perimeter edge 214 and two side perimeter edges 215.

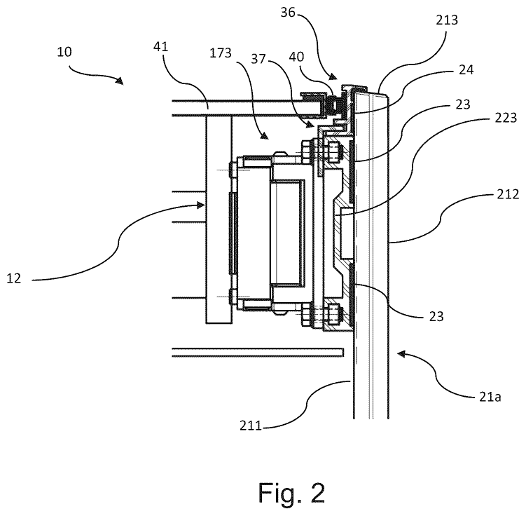

At least one fixing frame is glued to each glass wall 21, on its inner face 211, by means of a suitable adhesive 23, for example a so-called structural type adhesive; in the showcase 10 illustrated in FIGS. 2-5, two fixing frames are provided, an upper fixing frame 223 at the upper part of the glass wall 21, and a lower fixing frame 224 at the lower part of the glass wall 21. It is also possible to provide a single fixing frame in place of the two distinct upper 223 and lower 224 fixing frames.

Each fixing frame 223, 224 of each glass wall 21 is mounted on the supporting structure 12.

In the case of the openable glass wall 21a, the supporting structure 12 provides opening members for mounting the fixing frame 223, 224. In the showcase 10 illustrated in the figures, the openable glass wall 21a is of the hinged type and the opening members are formed by a pair of hinges, an upper hinge 173 and a lower hinge 174, on which the two respective fixing frames 223 and 224 are fixed.

The showcase 10 then comprises a safety profile 30 at the lower perimeter edge 214 of each glass wall 21 or 21a, to avoid the risk of accidental fall of the glass walls 21. Each safety profile 30 comprises a fixing portion 32 and a retaining portion 33.

The fixing portion 32 is shaped so as to remain resting on the inner face 211 of the glass wall 21, near the lower perimeter edge 214, and preferably also on the fixing frame 224.

The retaining portion 33 is shaped in such a way as to rest and be hooked to the upper perimeter edge 214 of the glass wall 21, so as to retain the glass wall 21 against the fixing portion 32.

Preferably, the safety profile 30 does not protrude on the outer face 212 of the glass wall 21, as its retaining portion 33 rests only on the upper perimeter edge 214.

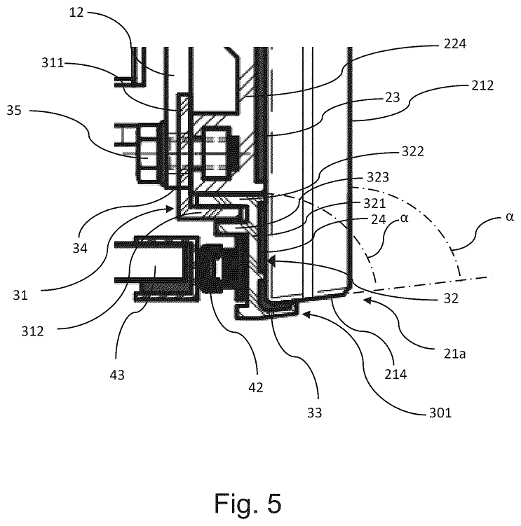

The safety profile 30 is mechanically fixed to the fixing frame 224 by means of one or more brackets 31 coupled to the safety profile 30 itself. To this end, the bracket 31 comprises two segments arranged in an “L” shape: a first segment 311 extended vertically and a second segment 312 extended horizontally. The fixing portion 32 of the safety profile 30 comprises in turn a first vertically extended segment 321 and two second horizontally extended, parallel segments: a second upper segment 322 and a second lower segment 323. The two second segments 322 and 323 are spaced apart from one another by a distance substantially equal to the thickness of the second segment 312 of the bracket 31; the second segment 312 of the bracket 31 is inserted wedged between the two second segments 322 and 323 of the fixing portion 32 of the safety profile 30, as best seen in FIG. 5.

Preferably, the lower perimeter edge 214 of the glass wall 21 is inclined, so as to form an acute angle α with the inner face 211 and with the outer face 212 of the glass wall 21. The retaining portion 33 of the safety profile 30 is correspondingly inclined at the same acute angle α with respect to the first segment 321 of the fixing portion 32 of the same safety profile 30.

The first segment 311 of the bracket 31 is provided with a hole 34, for mechanical fixing to the fixing frame 224. To this end, the bracket 31 is arranged with its first segment 311 interposed between the fixing frame 224 and the supporting structure 12 of the showcase 10; a screw 35 constrains the fixing frame 224 to the supporting structure 12 of the showcase 10 by passing through the hole 34 in the bracket 31. Consequently, the safety profile 30 is mechanically fixed both to the fixing frame 224 and to the supporting structure 12 of the showcase 10.

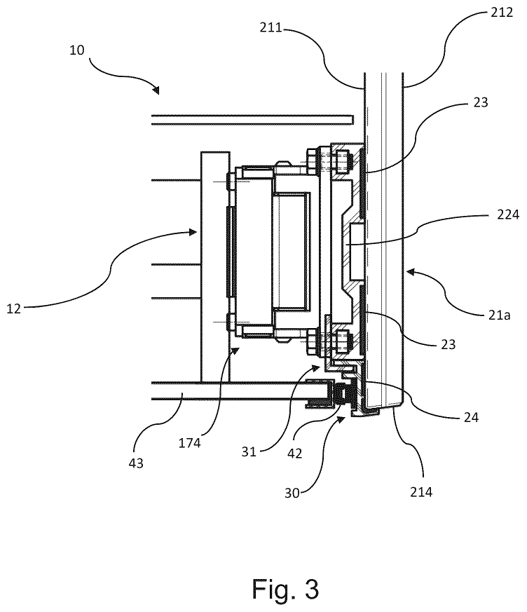

As can be well understood from FIGS. 3 and 5, the weight of the glass wall 21 is discharged both on the adhesive 23 and onto the retaining portion 33 of the safety profile 30. Thus, this weight is discharged along the section of the safety profile 30, from the retaining portion 33 to the first segment 321 and then to the second upper segment 322; from the latter, the weight is transferred on the second segment 312 of the bracket 31 through the latter on the fixing frame 224 and on the supporting structure 12, thanks to the screw 35. The shear stress on the adhesive 23 is therefore reduced.

Each glass wall 21 is optionally provided with a further safety profile 36, located at the upper perimeter edge 213 and similar to the safety profile 30. Each safety profile 36 comprises a fixing portion 38 and a retaining portion 39.

The fixing portion 38 is shaped so as to remain resting on the inner face 211 of the glass wall 21, near the upper perimeter edge 213, and preferably also on the fixing frame 223.

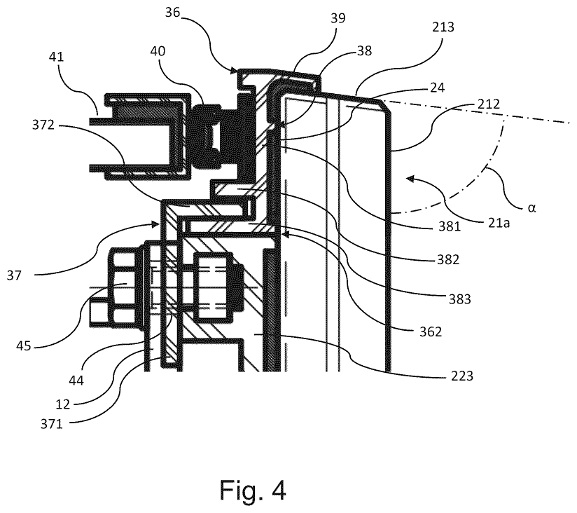

Similarly to the safety profile 30, the further safety profile 36 is also mechanically fixed to the fixing frame 223 by means of one or more brackets 37, coupled to the safety profile 36 itself. To this end, the bracket 37 comprises two segments arranged in an “L” shape: a first segment 371 extended vertically and a second segment 372 extended horizontally. The fixing portion 38 of the safety profile 36 comprises in turn a first vertically extended segment 381 and two second horizontally extended, parallel segments: a second upper segment 382 and a second lower segment 383. The two second segments 382 and 383 are spaced apart from one another by a distance substantially equal to the thickness of the second segment 372 of the bracket 37; the second segment 372 of the bracket 37 is inserted wedged between the two second segments 382 and 383 of the fixing portion 38 of the safety profile 36, as best seen in FIG. 4.

Preferably, the upper perimeter edge 213 of the glass wall 21 is inclined, so as to form an acute angle α with the inner face 211 and with the outer face 212 of the glass wall 21. The retaining portion 39 of the safety profile 36 is correspondingly inclined at the same acute angle α with respect to the first segment 381 of the fixing portion 38 of the same safety profile 36.

The first segment 371 of the bracket 37 is provided with a hole 44, for mechanical fixing to the fixing frame 223. To this end, the bracket 37 is arranged with its first segment 371 interposed between the fixing frame 223 and the supporting structure 12 of the showcase 10; a screw 45 constrains the fixing frame 223 to the supporting structure 12 of the showcase 10 by passing through the hole 44 in the bracket 37. Consequently, the safety profile 36 is mechanically fixed both to the fixing frame 223 and to the supporting structure 12 of the showcase 10.

The additional safety profile 36 improves the stability of the glass wall 21; however, it does not contribute to supporting the weight of said glass wall 21, due to its position, above the glass wall 21.

Optionally, filling material, for example adhesive material 24, is inserted between the profiles 30 and 36 and the glass wall 21. This adhesive material 24, however, unlike the adhesive material 23, does not participate in supporting the weight of the glass wall 21, but only has the dual function of promoting contact and sealing.

The museum showcase 10 is then provided—as shown in part in the drawings—with other typical elements, in themselves conventional and unrelated to the present disclosure. For example, in FIGS. 2-5 a sealing gasket 40 mounted on a ceiling 41 and a sealing gasket 42 mounted on a bottom 43 are visible; both these gaskets 41 and 42 are compressed by the openable glass wall 21a, when this is in the closed position.

The museum showcase 10 guarantees the protection, visibility and correct enjoyment of the objects displayed inside it as a conventional showcase with glued glass walls. The safety profiles 30 and 36 are in fact substantially invisible from the outside, especially if they do not protrude on the external faces 212 of the glass walls 21. The weight of the glass walls 21 is supported together by the safety profile 30 and by the adhesive 23, which also guarantees—together with the gaskets 40 and 42—that the showcase 10 is airtight.

The adhesive 23 thus supports only a part of the weight of the glass wall 21 and is therefore less prone to deterioration over time. Furthermore, should a failure of the adhesive 23 still occur, due to ageing, environmental conditions, insufficient adhesion strength or due to any other cause, the museum showcase 10 proves to be much safer than a conventional showcase with glued glass walls. In fact, in such a case—unlikely but not impossible—the failure of the adhesive 23 results in the detachment of the glass wall 21 from its fixing frames 223 and 224, but not in the fall of the glass wall 21 that remains in place, retained by the safety profile 30, optionally aided by the safety profile 36. All risks linked with the possible fall of the glass wall 21, both for people near the showcase 10, and for the objects displayed in the showcase 10, are therefore avoided. In addition, the showcase 10 remains closed and the public present does not have the possibility to access the objects displayed.

Of course, if the sealing of the adhesive 23 ceases, the pressure that the glass wall 21 exerts on the gaskets 40 and 42 is reduced and therefore the perfect airtightness of the showcase 10 is no longer ensured. However, the glass wall 21 remains in place and any air exchange between the interior of the showcase 10 and the external environment is thus very limited, so as to allow the personnel entrusted with the showcase 10 to intervene and secure the objects displayed.

It is therefore a much improved situation compared to the one that takes place when the adhesive in a conventional showcase with glued glass walls fails, in which—apart from the risks linked with the impact of the falling glass wall—the showcase is suddenly completely open, with the objects displayed that are both hit by the ambient air, and at the mercy of the public present who can access the interior of the showcase.

1. A museum showcase comprising:
a supporting structure,
a glass wall with an inner face and an outer face with respect to the museum showcase and with an upper perimeter edge and a lower perimeter edge,
a fixing frame glued to the inner face of the glass wall and mounted on the supporting structure of the showcase by mechanical fixing, and
a safety profile at the lower perimeter edge of the glass wall, the safety profile comprising a fixing portion and a retaining portion,
wherein the fixing portion is fixed to the fixing frame by mechanical fixing,
wherein the fixing portion rests at least partially on the inner face of the glass wall near the lower perimeter edge of the glass wall, and
wherein the retaining portion is hooked to the lower perimeter edge of the glass wall to support the glass wall resting against the fixing portion of the safety profile.

2. The museum showcase according to claim 1,
wherein the retaining portion does not protrude on the outer face of the glass wall.

3. The museum showcase according to claim 1,
wherein the lower perimeter edge of the glass wall is inclined, to form an acute angle α with the inner face, and
wherein the retaining portion of the safety profile is inclined at the acute angle α with respect to the fixing portion of the safety profile.

4. The museum showcase according to claim 1,
wherein the mechanical fixing of the fixing portion to the fixing frame comprises at least one bracket and a screw, the at least one bracket coupled to the fixing portion of the safety profile and comprising a hole into which the screw is inserted, the screw configured to fix the bracket to the fixing frame.

5. The museum showcase according to claim 4,
wherein said screw is configured to fix the fixing frame to the supporting structure.

6. The museum showcase according to claim 1,
wherein the glass wall is a fixed glass wall.

7. The museum showcase according to claim 1,
wherein the glass wall is an openable glass wall and the supporting structure comprises opening members, and
wherein the fixing frame of the openable glass wall is mounted on the opening members of the supporting structure.

8. The museum showcase according to claim 1, further comprising a second safety profile for the glass wall, at the upper perimeter edge of the glass wall.
